(19) United States
(12) Patent Application Publication
(10) Pub. No.: US 2026/0131502 A1
(43) Pub. Date: May 14, 2026

(54) SYSTEMS AND METHODS FOR CLAY COMPOSITE BASED CONSTRUCTION

(71) Applicant: Terran Robotics Inc., Bloomington, IN (US)

(72) Inventors: Rohit Bhikule, Bloomington, IN (US); Jacob Bower-Bir, Indianapolis, IN (US); Zach Dwiel, Bloomington, IN (US); Nicholas Ely, Ellettsville, IN (US); Nathanael O'donnell, Bloomington, IN (US); Madhur Padavala, Bloomington, IN (US); Daniel Weddle, Bloomington, IN (US); Randal Pope, Bloomington, IN (US)

(21) Appl. No.: 18/942,272

(22) Filed: Nov. 8, 2024

(51) Int. Cl. B28B 17/00; B25J 9/10; B25J 11/00; B28B 1/00

(52) U.S. Cl. CPC B28B 17/0081; B25J 9/104; B25J 11/005; B28B 1/00

(57) ABSTRACT

Systems and methods for clay composite based construction are disclosed. The system includes control towers spaced apart and surrounding a build area. The system includes a carriage having build tools suspended over the build area by cables attached to, and supported by, the control towers. The build tools include a claw for picking-up clay composite materials from the build area, transporting the clay composite materials, and placing clay composite materials onto the build area, and a hammer for sculpting the clay composite materials placed onto the build area. The system includes a processing module connected to the control towers, the processing module controlling the operation of the carriage to form clay composited based structures.

### TECHNICAL FIELD

The present disclosure generally relates to systems and methods for clay composite based construction.

### BACKGROUND

Conventional 3D printing systems for construction applications can include extrusion printers, pick-and-place block formers, among other systems. The extrusion printers can be configured to form monolithic structures, while the pick-and-place block formers can be configured to form non-monolithic structures. In some examples, the extrusion printers can be configured to produce walls using a wet mix extrusion technique. The wet mixes of the extrusion printers, however, are not microfiber reinforced, and do not result in walls solid throughout. In one example, extrusion printers can be configured to form in situ 3D printed adobe structures. The pick-and-place block formers on the other hand pick-up a solid block or stone, and place the block in a planned configuration to form a particular structure. In one example, structures formed by the pick-and-place block formers are discontinuous, and can be reinforced using cold joints, adhesive, and/or mortar connecting individual blocks.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the systems and methods described herein. In the following description, various embodiments are described with reference to the following drawings.

FIG. 1A illustrates a table showing exemplary clay composite properties, according to some embodiments.

FIG. 1B illustrates a block diagram for a system for clay composite based construction, according to some embodiments.

FIG. 2 illustrates a plan view of a system for clay composite based construction, according to some embodiments.

FIG. 3 illustrates a plan view of a build module for clay composite based construction, according to some embodiments.

FIG. 4A illustrates a plan view of a carriage, according to some embodiments.

FIG. 4B illustrates another plan view of the carriage, according to some embodiments.

FIG. 5A illustrates a plan view of a hammer in an extended position, according to some embodiments.

FIG. 5B illustrates a plan view of the hammer in a retracted position, according to some embodiments.

FIG. 6A illustrates a plan view of the hammer in a vertical position, according to some embodiments.

FIG. 6B illustrates a plan view of the hammer in a horizontal position, according to some embodiments.

FIG. 7A illustrates a claw closed, according to some embodiments.

FIG. 7B illustrates the claw open according to some embodiments.

FIG. 8 illustrates method for forming clay composite based structures, according to some embodiments.

FIG. 9 illustrates method for forming clay composite based structures, according to some embodiments.

FIG. 10 illustrates a diagram of an exemplary hardware and software systems implementing the systems and methods described herein, according to some embodiments.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### SUMMARY

Systems and methods for clay composite based construction are presented. In some embodiments, the system can include control towers spaced apart and surrounding a build area. In some examples, the system can include a carriage having build tools suspended over the build area by cables attached to, and supported by, the control towers. In some examples, the build tools can include a claw for picking-up clay composite materials from the build area, transporting the clay composite materials, and placing clay composite materials onto the build area, and a hammer for sculpting the clay composite materials placed onto the build area. The system can include a processing module connected to the control towers, the processing module controlling the operation of the carriage to form clay composited based structures.

Various embodiments of the system can include one or more of the following features.

In some embodiments, the control towers can include at least 4 control towers. In some examples, the system can include at least one of communication devices, sensors, or machine vision devices. The build tool can include at least one of a saw, a drill, an impulse hammer, or end effectors. The processing module can include at least one of an artificial intelligence module, a machine vision module, a storage module, a communication module, a control module, or an user interface module. The control towers can include at least one of pulleys, winches, cable spools, or motors. In some embodiments, the control towers can include lifting devices configured to control the movement of the carriage via the cables connecting the carriage to the control towers. The processing module can be configured to use an artificial intelligence module to control the operation of the carriage to form clay composited based structures. The clay composite materials can include at least one of clay aggregates, fibers, microfibers, cob, or viscous cob materials.

A method for forming clay composite based structures is presented. In some embodiments, the method can include picking-up a clay composite material from a first location of a build area. In some examples, the method can include transporting the clay composite material over a second location of the build area. The method can include placing the clay composite material onto the second location. The method can include sculpting the clay composite material. The method can include cutting or carving the clay composite material to form a clay composite based structure.

Various embodiments of the method can include one or more of the following steps.

In some embodiments, the method can include picking-up the clay composite material using a claw attached to a carriage to pick up a clay composite material from the build area. In some examples, the method can include transporting the clay composite material using a claw and a carriage driven by cables attached to control towers. The method can include placing the clay composite material using a claw attached to a carriage to place the clay composite material onto the build area. The method can include picking-up, transporting, and placing the clay composite materials to form a monolithic structure. The method can include using sensors and machine vision devices to determine a first location to pick-up the clay composite materials. In some examples, the first location can be a separate, different, location from the second location. The method can include sculpting the clay composite material using a hammer to sculpt the clay composite material into a clay composite based structure. The method can include cutting or carving the clay composite material using a saw to cut or carve the clay composite material into a clay composite based structure. The method can include performing cutting or carving the clay composite subsequent to sculpting the clay composite material.

### DETAILED DESCRIPTION

Systems and methods for clay composite based construction are presented, according to some embodiments. In some embodiments, the systems and methods presented herein can be used to perform additive, formative, and subtractive construction using clay composite materials. In some examples, the systems and methods include picking-up clay composite materials, placing the clay composite materials according to an architectural plan and/or according to a 3D model, and optionally sculpting the clay composite materials to form a clay composite based structure. For example, the sculpting process can be similarly additive, formative, and/or subtractive. In some examples, the clay composite materials used by the system can be described as and/or referred to as a “cob”, “bauge”, “adobe”, “pisé”, and/or “earth”, among other terms, and the description of the clay composite material can be accompanied by qualifiers such as “in situ”, “monolithic”, “de terre”, and “rammed”, among other terms and their qualifiers. The same or similar terms can also be used to refer to a variety of building techniques performed by the system and that use these and related clay composites,. The building techniques may or may not involve formwork to hold the clay composite material together, and may or may not include active compression of the material itself. The clay composites used by the system can include soils and subsoils, aggregate materials, and fiber materials, among others. The ratios of the clay composite materials and other ingredients can be systematically adjusted to meet specific criteria. The systems and methods presented herein can be used to form three dimensional (3D) structures. In some examples, the systems and methods can be used to form walls, foundations, architectural apertures such as window and door openings, architectural ornamentations, and built-in furniture, among other structures and features for residential, commercial and/or industrial construction. The systems and methods can be used to form residential homes and apartments, commercial office buildings, and/or industrial manufacturing buildings, among other structures. The systems and methods presented herein can be used to form monolithic structures. Monolithic structures can include at least one of: structures formed without joints or seams, structures made up of the same material continuously throughout, structures made up of a single unit or piece, among other examples. The systems and methods can be used to form microfiber reinforced, and/or solid structures. In some examples, the systems and methods can be used to form walls that are monolithic, reinforced, and solid. In some embodiments, the system and methods presented herein can use clay composite materials that can include loose and/or wet and/or viscoplastic material, which can be picked up, transported, placed, and hammered (e.g., by the systems and methods presented herein) without formwork to form a structure such as a wall.

The systems and methods presented herein provide an improvement over conventional 3D printing systems used for construction applications. For example, conventional 3D printing systems used for construction applications can include extrusion printers, pick-and-place block formers, among other systems. The extrusion printers can be configured to form monolithic structures, while the pick-and-place block formers can be configured to form non-monolithic structures. In some examples, the extrusion printers can be configured to produce walls using a wet mix extrusion technique. The wet mixes of the extrusion printers, however, are not microfiber reinforced, and do not result in walls solid throughout. The systems and methods presented herein form walls that are monolithic, microfiber reinforced, and solid throughout. Pick-and-place block formers on the other hand pick-up a solid block or stone, and place the block in a planned configuration to form a particular structure. In one example, earthen blocks used by the pick-and-place block formers can be reinforced using adhesive, and/or mortar to connect individual blocks. The structures made by the pick-and-place block formers are discontinuous in nature, e.g., are non-monolithic because the structures are made up of individual blocks which can be held together by cold joints between spaces of individual blocks. Additionally, the blocks used by the pick-and-place block formers may not be standardized in shape and position, providing for irregularities in the finished build. In contrast, the systems and methods presented herein form continuous clay composite structures that are solid and reinforced by aggregate materials (e.g., fibers, microfibers, cob, etc.).

As used herein, 3D forming and 3D printing can be used to describe the forming three dimensional monolithic structures. In some examples, 3D forming and 3D printing can be used herein interchangeably. 3D forming, and hence 3D printing, can include picking-up one or more clay composite materials, placing the clay composite materials based on a plan, and optionally sculpting the clay composite materials, to form the 3D structure. Other terms for 3D forming can include, but are not limited to, earthen based additive construction, cob construction, and/or formative rammed earth construction.

As described herein, like reference numbers refer to similar or the same components within the figures. For example, the description referring to a system 200 can be used to refer and/or describe a system 100, and vice versa.

### Clay Composite Materials

Systems and methods that make use of clay composite materials for construction are presented. The clay composite can include clay and related soils and subsoils, various types of construction aggregates, and organic and synthetic fibers and microfibers, among other materials. During the building process, one or more properties of the clay composite can be adjusted. In some examples, the viscosity and/or plasticity of the clay composite can be adjusted based on one or more target properties of a construction project, and/or characteristics of the project's local environment. The clay composite materials can be configured for targeted improvements in structural integrity, environmental friendliness, human health, and/or financial savings. The composition of the clay composite material can be varied based on one or more targets requested and/or provided by a customer. The composition of the clay composite material can be varied based on properties, attributes, characteristics, contexts, and/or features for a particular project and/or a particular structure. In some embodiments, the clay composite material can include a mix of components. In some examples, the components can include a binder, an aggregate, and/or a fiber. In one example, the clay composite material can be a mix of the three or more components. In some examples, one or more binders, aggregates and/or fibers can be used. The clay composite materials can include clay, which can serve as the binder. The clay composites can include materials defined in Appendix AU of the International Residential Code (IRC).

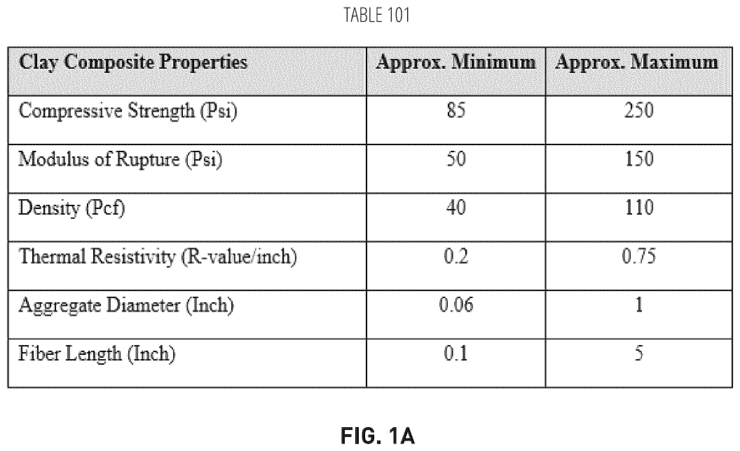

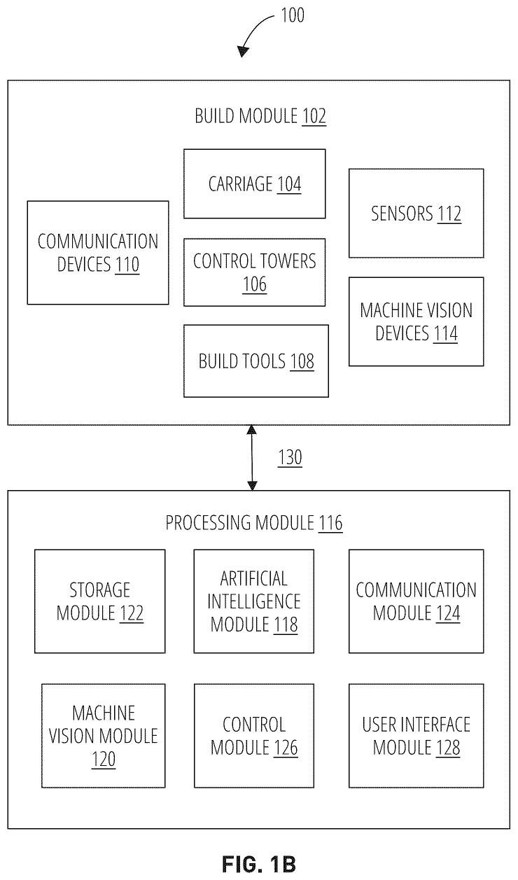

Referring to FIG. 1A, a Table 101 showing exemplary clay composite properties is shown, according to some embodiments. In some embodiments, the clay composites properties can include compressive strength (Psi), modules of rupture (Psi), density (Pcf), thermal resistivity (R-value/inch), aggregate diameter (inches), and/or fiber length (inches). In some examples, the thermal resistivity can be measured by the equation (ft²×F×h/BTU)/inch, where the R-value=ft²×F×h/BTU. The clay composites can include a compression strength equal to and/or within a range of approximately 85-250 Psi. In one example, the clay composites can include a compression strength equal to and/or within a range of approximately 60-400 Psi. The clay composites can include a modulus of rupture equal to and/or within a range of approximately 50 -150 Psi. In one example, the clay composites can include a modulus of rupture equal to and/or within a range of approximately 50 -250 Psi. The clay composites can include a density equal to and/or within a range of approximately 60-110 Pcf. In one example, the clay composites can include a density equal to and/or within a range of approximately 20-150 Pcf. The clay composites can include a thermal resistivity (e.g., resistivity) equal to and/or within a range of approximately 0.2-0.6 R-value/inch. In one example, the clay composites can include a thermal resistivity equal to and/or within a range of approximately 0.1-1.3 R-value/inch. In some embodiments, the aggregates and/or fibers of the clay composites can be configured to enhance selective features of the clay composite material used as a whole. In some examples, the clay composites can include an aggregate diameter equal to and/or within a range of 0.125-0.75 inches. In one example, a foam glass aggregate can be used. Such an exemplary size can balance the compressive strength and/or the thermal resistance (e.g., the R-value) of the clay composite. In one example, the clay composites can include an aggregate diameter equal to and/or within a range of 0.06-0.75 inches. Specific lengths of straw and other fibers (e.g., basalt, hemp, and others) can be used and/or configured to augment both the thermal resistance and/or elasticity of the clay composite. Various lengths of straw and other fibers of the clay composites can be used. In some examples, the clay composites can include a fiber length equal to and/or within a range of approximately 1-3 inches. In one example, the clay composites can include a fiber length equal to and/or within a range of approximately 0.1-5 inches. One or more layers of clay composite materials can be referred to herein as “lifts”.

In some embodiments, the clay composite material can include a substantially viscous material. In some examples, the benefits of using clay composite materials in construction include inheriting the properties of the clay composite materials into the structure to be formed. The clay composite material can have the following properties including sound proofing, increased insulative value, passive performance as a humidity, and/or thermal battery, among other properties. The clay composite material can be referred to as modeling of cob, and/or formative construction.

### Block Diagram for a System for Clay Composite Based Construction

Referring to FIG. 1B, a block diagram for a system for clay composite based construction 100 is shown, according to some embodiments. In some embodiments, the system 100 can be used to perform compound manufacturing techniques. In some examples, compound manufacturing can include additive manufacturing, formative manufacturing, and/or subtractive manufacturing. The system 100 can include interchangeable tools and/or equipment. In some embodiments, the system 100 can be used to and/or is configured to use a variety of construction materials. In some examples, the system 100 can use and/or is configured to use clay composites and/or earthen materials. The system 100 can be used to and/or is configured to be adaptable, self-reliant, and/or be able to detect and/or correct errors in the compound manufacturing process. The system 100 can use and/or be configured to use artificial intelligence (AI) algorithms, machine learning algorithms, neural network algorithms, machine vision algorithms, reinforcement learning algorithms, among other algorithms. The system 100 can be trained based on real world data and/or simulated data. The system 100 can be assembled, disassembled, and/or is reconfigurable.

Referring again to FIG. 1B, the system 100 can include a build component build module 102 and processing module 116, according to some embodiments. In some embodiments, the build module 102 together with the processing module 116 can be used to and/or are configured to perform additive, formative, and/or subtractive construction. In some examples, the build module 102 together and the processing module 116 can be used to perform additive, formative, and/or subtractive construction using the same material substrate, e.g., using clay composites. In one non-limiting example, the build module 102 can be used to perform one or more additive, formative, and/or subtractive construction techniques under instruction from the processing module 116. Each of the systems 102, 104 can be modular, e.g., each can include one or more components, modules and/or sub-modules. In some embodiments, the system 100 can include a feedback loop control system. In some examples, the system 100 be used to and/or be configured to perform the feedback loop control. The system 100 can concurrently (i) map the build module's 102 environment including mapping the position of each component of the build module 102, and (ii) position a carriage of the build module 102 within the mapping. In some embodiments, the system 100 can be adaptive, e.g., may be self-controlled and perform compound manufacturing without human intervention using the build module 102 and/or the processing module 116.

In some embodiments, the system 100 can be fully automated, partially automated, and/or manually controlled. In some examples, the build module 102 and the processing module 116 together can be used to fully automate and/or control the system 100. In some examples, the processing module 116 can control the build module 102 to perform compound manufacturing without human intervention. In another example, the build module 102 can be used with the assistance of a human operator and the processing module 116 together. In still another example, the processing module 116 is not used, and a human operator can control the build module 102 directly. Depending on the tool being used, system 100 can provide a variety of roles. In some examples, when using a claw for the build tool 108 to lift or help lift an object, the system 100 can be configured to perform tasks similar to that of a construction crane. When the system 100 is assembling discrete masses of clay composite material into structure, the system 100 can be described as performing 3D printer processes for monolithic construction. Additive, formative, and subtractive tools may operate independently from each other.

### Build Module for Clay Composite Based Construction

Referring again to FIG. 1B, in some embodiments, the build module 102 can include a carriage 104, control towers 106, build tools 108, a communication device 110, sensors 112, machine vision devices 114, among other components. In some embodiments, the carriage 104 can include a robot suspended on a cable connected to the control towers 106. In some examples, the carriage 104 can include a cable driven robot. The carriage can be suspended at an approximately 2-3 degrees of freedom. The build tools 108 can be mounted onto the carriage 104. The carriage 104 can be used to position the build tools 108 during operation of the system 100. The build tools 108 can include interchangeable tools used by the build module 102 to perform the pick-up, placement, and/or sculpting of clay composite materials. The build tools 108 can include a claw, a crane, a hammer, a saw, a drill, end effectors, among other tools and/or equipment. The sensors 112 can be used to detect the location of the carriage 104 while performing compound manufacturing. In some examples, the sensors 112 can detect the movement and/or position of the carriage 104 on the cables, and use that information to generate localization information of the carriage 104. The sensors 112 can be mounted on the carriage 104 and the control towers 106. The sensors 112 can be used to determine ambient properties of the system 100, e.g., temperature, etc. The machine vision devices 114 can be used to view, inspect, detect, and/or capture a location of the carriage 104. In some examples, the machine vision devices 114 can be mounted onto the control towers 106. The machine vision devices 114 can be used to view, inspect, detect, and/or capture the movement and/or position of the carriage 104 on the cables, and use that information to generate localization information of the carriage 104. The machine vision devices 114 can include cameras and/or other vision-based equipment. The control tower 106 can be used to move the carriage 104 over a build plate of the system 100. The build module 102 can use the communication device 110 to receive instructions for the processing module 116 and/or send information to the processing module 116.

In some embodiments, the build module 102 can include an autonomous, fully actuated, and/or cable driven robot for performing compound manufacturing. In some examples, the build module 102 can use the carriage 104, control towers 106, communication devices 110, sensors 112, and/or machine vision devices 114 to perform the pick-up, placement, and/or sculpting of clay composite materials to form structures for residential, commercial, and/or industrial applications.

In some embodiments, the build module 102 can be fully actuated and autonomous. In some examples, the build module 102 can use machine vision devices 114, e.g., such as mounted cameras, to register a position of the carriage 104 in relation to computer vision tags and/or markers dispersed across a build site. In some examples, localization information can be gathered by the build module 102 based on the computer vision tags and/or markers. The build module 102 can generate the localization information based on information received from the sensors 112 and/or machine vision devices 114. The localization information can include images, sound, radar, sonar, lidar, information, among other information. The build module 102 can be piloted by the processing module 116 using the localization information to control the build tools 108 to perform compound manufacturing (e.g., additive, formative, and/or subtractive manufacturing).

### Processing Module for Clay Composite Based Construction

Referring to FIG. 1B, in some embodiments, the processing module 116 can include an artificial intelligence module 118, a machine vision module 120, a storage module 122, a communication module 124, a control module 126, a user interface module 128, among other modules. The processing module 116 can be used to communicate and/or control 130 the build module 102. The processing module 116, can be used to and/or are configured to perform simultaneous localization and mapping (SLAM) based on data received from the sensors 112 and machine vision devices 114 to gather localization information to be used by the build module 102 for performing clay composite based construction. In some embodiments, the artificial intelligence module 118 can include software and/or hardware for implementing AI algorithms, AI models, among other AI software implementations. In some examples, the artificial intelligence module 118 can use information from the SLAM. In some examples, the SLAM can include inside out SLAM, e.g., SLAM that can make use of cameras of the build module which are looking outward to the surrounding area. The artificial intelligence module 118 can be used to command, control, and/or instruct 130 the movements build module 102, e.g., using the AI algorithms and/or AI models. The artificial intelligence module 118 can be portable across different configurations of the processing module 116, and/or can be compatible with one or more other build modules 102. In some embodiments, artificial intelligence module 118 can perform localization using the build module 102. In some examples, the artificial intelligence module 118 can track where the carriage 104 of the build module 102 is in space, and calculate and/or estimate where the carriage 104 is headed.

In some embodiments, the build module 102 and the processing module 116 can together form a feedback loop control system. In some embodiments, the build module 102 and the processing module 116 can together be used to and/or be configured to perform feedback loop control. The processing module 116 can (i) map the build module's 102 environment, and (ii) instruct the build module 102 to position the carriage 104 based on the mapping. In some examples, the processing module 116 can be used to and/or is configured to perform simultaneous localization and mapping (SLAM) using the build module 102. The processing module 116 can use localization information received from the build module 102 to determine a position and/or place of the carriage 104 of the build module 102 within a build area of the build module 102. In some examples, the processing module 116 can generate a forward kinematic solution for the carriage 104 based on the localization information received from the build module 102. The processing module 116 can use the localization information to identify building materials to be used, recognize where the material to be placed based on a plan, plot a course for moving the material, and control the build module 102 to place the material at the target location. The processing module 116 can include and/or use one or more computer vision algorithms, machine learning (ML) algorithms, neural network algorithms, among other algorithms to determine a forward kinematic solution. In one example, the processing module 116, using the neural network algorithms, can be trained using data obtained from cameras of the build module 102. The processing module 116 can be used to and/or configured to identify where the carriage 104 of the build module 102 is in space, anticipate where the carriage will need to be to perform a particular task, and move the carriage to a target position to perform the task. The processing module 116 can be trained using data obtained from sensors 112, and/or machine vision devices 114 of the build module 102. The processing module 116 can use the machine vision devices 114 of the build module 102 to identify build tools 108 (e.g., additive, formative and/or subtractive tools) to be used by the build module 102, recognize where build tools 108 are to be placed and/or used, plot a course for moving the build tools 108 to the target location, and using the build tools 108 at the target location.

In some embodiments, the processing module 116 can be used to and/or is configured to control picking and placing of the clay composite material using a claw attachment build tool 108 of the build module 102. In some examples, the build module 102 can be used to and/or is configured to perform the picking and placing of the clay composite material based on instructions from the processing module 116. The processing module 116 can perform a combination of computer vision and machine learning techniques to perform additive, formative and/or subtractive construction. In some examples, the processing module 116 be used to and/or is configured to identify and/or smoothen uneven portions of the structure to be formed using a hammer of the build tool 108 of the build module. The processing module 116 be used to and/or is configured to identify and fill-in areas of a structure for filling. In one non-limiting example, the processing module 116 can use SLAM information to identify and/or smoothen uneven portions of a wall using the chassis-mounted impact hammer, and identifying and filling in areas of the wall that need more material.

In some embodiments, the processing module 116 be used to and/or is configured to determine areas of a structure that can be improved and/or addressed, and to instruct the build module 102 to perform actions to improve and/or address the particular areas of the structure. In some examples, the processing module 116 can use information about the pliability of clay composite material used to determine improvements to be made to the structures formed. The processing module 116 can be modular. The processing module 116 can be ported and/or used from one build module 102 to another build module. The processing module 116 can use and/or is configured to learn how to operate newly introduced build tools 108, variant and/or upgraded configurations of the build module 102, and/or maneuver the build module 102 regardless of the configuration.

### System for Clay Composite Based Construction

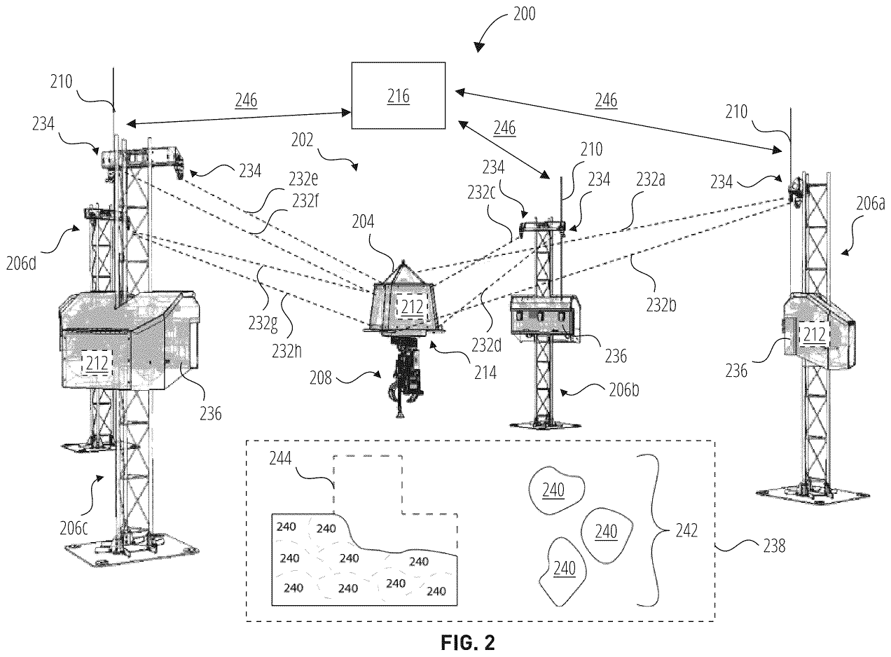

Referring to FIG. 2, a plan view of a system 200 for clay composite based construction is shown, according to some embodiments. In some embodiments, the system 200 can be used to and/or is configured for residential, commercial and/or industrial construction. In some examples, the system 200 can be used to and/or is configured for forming residential homes, residential apartments, commercial office spaces, and/or industrial buildings, among other structures. The system 200 can be used for and/or is configured for performing compound manufacturing techniques, e.g., as described in FIG. 1B. The system 200 can be configured to provide affordable construction processes, practical transportation techniques, faster to assemble, faster to disassemble, and/or scale in comparison to other 3D printers and 3D printers used to build monolithic construction systems and perform monolithic construction processes. In some embodiments, the system 200 can include a build module 202 and processing module 216. The build module 202 is configured to lift approximately 200 lbs of weight.

In some embodiments, the build module 102 can include a carriage 204, control towers 206a-206d, build tools 208, communication devices 210, sensors 212, machine vision devices 214, among other components. The carriage 204 can be suspended over a build area 238 by four control towers 206a, 206b, 206c, 206d, using cables 232a, 232b, 232c, 232d, 232e, 232f, 232g, 232h, sensors 212, a machine vision device 214, as shown in FIG. 2. The control towers 206a-206d can collectively be referred to herein as control towers 206. The cables 232a-232h can collectively be referred herein as cables 232. The carriage 204 can be suspended from eight cables 232a-232h connected to the control towers 206a-206d. The carriage 204 can include build tools 208 attached to the carriage 204. In one example, as shown in FIG. 2, the build tools 208 can include a claw, a hammer, a crane, among other tools attached to the carriage 204. The cables 232a-232h can have a length that can be adjusted. In some examples, rotations of the cables 232a-232h can be adjusted. The cables 232a-232h can be adjusted based on the height of the control towers 206, based on the structure 244, the build area 238, among other parameters. The height of the control towers 206a-206d can be adjusted. The height of the control towers 206a-206d can be adjusted based on the structure 244, build area 238, among other parameters. The control towers 206a-206d can include cable spools, and/or motors, among other components, connected to the cable 232a-232h for controlling the movement of the carriage 204 over the build area 238. In some examples, the build area 238 can have an area of at least 80 feet by 80 feet. In some embodiments, the build module 202 can include an aerial drone to move and orient carriage 204 around the build area 238.

In some embodiments, the system 200 can be configured to use clay composites 240 to form a monolithic structures 244. In some examples, the clay composites 240 can include viscous clay-based materials that include the properties described in FIG. 1A. For example, the clay composites 240 can be initially formed in discrete, irregularly shaped and sized chunks. Thus, as described herein, the clay composites 240 can be referred to interchangeably as clay composite chunks 240. In some exemplary non-limiting examples, the clay composites 240 can be formed into discrete shapes and be referred to as, but are not limited to, discrete masses, lumps, wedges, chunks, hunks, slabs, masses, nuggets, loaves, and/or gobs, among other terms. In one example, a grouping of more than one chunk of clay composite 240 can be referred to as a stack or pile 242.

In some embodiments, the system 200 can combine and/or shape the clay composites chunks 240 to form monolithic structures 244. In some examples, the monolithic structures 244 can be made up of compacted clay composite chunks 240. In one example, the clay composites 240 include discrete masses used by the system 200 in forming one or more compiled structures 244. As described herein, the one or more monolithic structures 244 can be referred to as structures 244, among other terms. In one non-limiting example, the system 200 can use one clay composite 240 (e.g., one clay composite chunk 240), or more clay composites 240 (clay composite chunks 240) to form the structures 244. In some examples, the system 200 can form one or more structures 244 that are each separately made up of their own corresponding clay composites 240 or clay composite chunks 240.

In some embodiments, the construction processes performed by the system 200 can be in contrast to the other 3D printer systems used for monolithic construction which do not make use of initially discreet, irregularly shaped and sized materials in construction. For example, the benefits of forming solid walls using the clay composites 240 can include maintaining advantageous properties of the clay composites 240 during and after the formation process. The properties of the clay composites 240 can include, but are not limited to providing sound proofing, fire proofing, thermal insulation, a thermal mass effect (i.e., temperature damping or lag), and passive regulation of indoor humidity. Many of the benefits provided by the clay composites 240 can be lost, and/or severely restricted, if used with conventional 3D printing construction systems and processes. For example, using the clay composites 240 in a conventional 3D printing process, e.g., such as in an extrusion process, can require adjustments to the base composition of the material, and can require the inclusion of additional materials within the structure. Thus, in contrast to the conventional 3D printing construction systems and processes, the system 200 performs a pick-and-place construction method that makes use of the clay composites 240 to form solid structures without gaps or cavities (e.g., unless specifically, intentionally incorporated within the structure to be formed), and that takes advantage of properties that the clay composites 240 provide.

Referring again to FIG. 2, in some embodiments, the system 200 can use the clay composites 240 for compound manufacturing (i.e., combinations of additive, formative, and subtractive fabrication techniques). In some embodiments, the system 200 form structural walls, nonstructural walls, fire walls, party walls, door apertures, window apertures, built-in furniture, and ornamentation, among other structural and nonstructural elements built using the clay composites 240. In some examples, the system 200 can be configured to pick, place, and form structures using the clay composites 240 described herein. The clay composites 240 can be formed into various shapes including cubical shapes, spherical shapes, among other shapes. In one example, the clay composites 240 can be formed into irregular shapes, e.g., formed in non-symmetrical shapes. The clay composites 240 can include a mixture of natural, earthen materials, among other materials. The clay composites 240 can include clay and related soils and subsoils, construction aggregates, and natural and synthetic fibers and microfibers, among other materials.

Referring to FIG. 2, in some embodiments, the system 200 can use the build tool 208 attached to the carriage 204 to pick-up, drop, sculpt, and/or carve the clay composites 240. In some examples, the system 200 can determine an approximate position of the clay composites 240 on the build area 238, pick-up the clay composites 240 at the determined position, and place the clay composites 240 at another position on the build area 238. The structure 244 can initially be formed by the placement of the clay composites 240 on the build area 238. The system 200 can sculpt the structure 244 by hammering the structure 244 into a target shape based on an architectural plan, and/or a 3D model, of the structure 244. The system 200 can hammer the structure 244 into a structure such as a wall, a buttress, an aperture, a niche, furniture, among others. The system 200 can be used to reinforce the structure 244 using the clay composites 240. In some examples, the resulting structure 244 can be microfiber reinforced via the clay composites 240 and the clay composites 240 can be amassed and/or shaped into formal architectural structural reinforcements such as buttresses, among other structures. In some examples, the structure 244 formed by the system 200 can be solid throughout.

In some embodiments, the carriage 204 and build tool 208 can be used to pick-up, transport, and place the clay composites 240 to form the structure 244. In some examples, a claw of the build tools 208 can be used to pick-up, transport, and place the clay composites 240. The structure 244 can be hammered by the build tool 208 after placement of the clay composites 240. The structure 244 can be cut and/or carved by the build tool 208 after placement of clay composites 240, and/or hammering. In another example, other external tools can be used to hammer, cut, and/or carve the structure 244 after placement of the clay composites 240. In still another example, humans can hammer, cut, and/or carve the structures 244 into a desired shape after placement of the clay composites 240. The build tool 208 can include a claw, a crane, a hammer, e.g., tools that can be used for job-site construction applications.

The control towers 206a-206d can include lifting devices 234. The lifting devices 234 can include pulleys, winches, cable spools, and/or motors. The spools and motors can be housed within control tower enclosures 236 of the control towers 206a-206d. The cables 232a-232h can originate from the cable spools and motors located within the control tower enclosures 236. The cables 232a-232h can run from lifting devices 234 of the control towers 206a-206d to the carriage 204. Each of the control tower enclosures 236 can independently adjust the cables 232a-232h to vary the lengths of cable extending from lifting devices 234. Adjusting a length of the cables 232a-232h extending from lifting devices 234 can move the carriage 204 up, down, and/or side-to-side along the build area 238. Adjusting the length of the cables 232a-232h can change an orientation of carriage 204. Adjusting the length of the cables 232a-232h extending from lifting devices 234 can allow for approximately six degrees of extension and/or contraction movement of the carriage 204, three degrees of translational movement of the carriage 204, and three degrees of rotational movement of the carriage 204. In some examples, the lifting device 234 can include a winch system. The winch system 234 can include approximately 3 plates of sheet steel on an axel. In some examples, the 2 plates can include outer plates, and the last plate can include an inner plate. The 2 outer plates can have a larger diameter in comparison to the inner plate. At least one of the 3 plates can have a thickness greater than the cable used by the winch system 234. Rotation of the spool, e.g., of the winch 234, can be measured. In some embodiments, the winch system 234 can be configured to precisely measure cable length, e.g., accommodating for changes of the cable radius as it wraps around the winch 234 or spool.

In some embodiments, the build tools 208 can include a claw, a hammer, an impulse hammer, a saw, a drill, and/or router, among other tools. In some examples, the claw can be supported by the carriage 204. The claw can be used to pick-up, transport, and place discrete pieces of clay composite 240 to form the structure 244. In some examples, discrete chunks of clay composites 240 can be added together to form the structure 244. The build module 202 can control a translational movement of the carriage 204. In some examples, the claw can pick-up and transport chunks of the clay composite 240 from one location of the build area 238, and place the chunks of the clay composite 240 to another location on the build area 238 to form the structure 244. The build module 202 can further include various tools, supported by carriage 204, for refining the shape of the structure 244. Controlling the three degrees of translational and/or rotational movement of carriage 204 allows for the build tools 208 to be positioned and oriented relative the structure 244 as the structure 244 is being constructed and its shape refined. The hammer can sculpt and/or pound structure 244 to change the shape of the structure 244. In some examples, drills, saws, and/or routers of the build tools 208 can be used to remove portions of the structure 244. The removal of material (e.g., clay composite 240) from the structure 244 to modify the shape of structure 244 can be referred to as subtractive construction. A claw and hammer of the build tools 208 can be used separately, e.g., each of the claw and hammer can be supported by the carriage 204 together and/or separately. The control towers 206a-206d can control the position and/or orientation of carriage 204. The extension and retraction of cable 232a from lifting devices 234 can change the position and orientation of carriage 204.

As shown in FIG. 2, cables 232a-232h can extend from lifting devices 234 on a respective control towers 206a-206d to the carriage 204, allowing translational and/or rotational movement of the carriage 204. In some examples, a first cable 232a and a second cable 232b can extend from a first control tower 206a, a third cable 232c and a fourth cable 232d can extend from a second control tower 206b, a fifth cable 232d and a sixth cable 232e can extend from a third control tower 206c, and a seventh cable 232f and an eighth cable 232h can extend from a fourth control tower 206d. Each of the cables 232a-232h can connect to a corresponding corner of the carriage 204. The sensors 212 can be located within the control tower enclosures 236 and the carriage 204. The machine vision devices 214 can be part of the carriage 204 and/or the control towers 206a-206d.

In some embodiments, the processing module 216 can be connected to the control towers 206a-206d. The carriage 204 can be piloted and/or controlled by the processing module 216. The carriage 404 can be piloted and/or controlled by an artificial intelligence (AI) module of the processing module 216. The AI module can control the carriage 204 and/or any of the interchangeable tools (e.g., a claw, hammer, among others) that there attached to the carriage 204. The processing module 216 can be connected 246 to the control towers, the processing module controlling the movement and operation of the carriage 204.

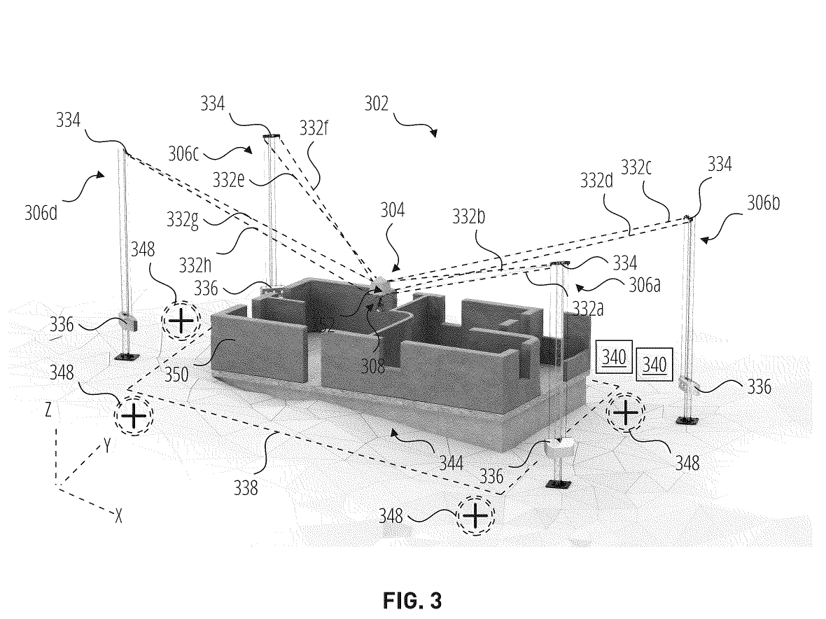

Referring to FIG. 3, a plan view of a build module 302 for clay composite based construction is shown, according to some embodiments. In some embodiments, the build module 302 can include a carriage 304, control towers 306a-306d, build tools 308, among other components. The carriage 304 can be suspended over a build area 338 by four control towers 306a-306d, using cables 332a-332h, as shown in FIG. 3. The control towers 306a 306d can collectively referred to herein as control towers 306. The cables 332a-332h can collectively referred herein as cables 332. The carriage 304 can be suspended from eight cables 332a-332h connected to the control towers 306a-306d. The carriage 304 can include build tools 308 attached to the carriage 304. In one example, as shown in FIG. 3, the build tools 308 can include a claw, a hammer, a crane, among other tools attached to the carriage 304. An exemplary structure 344 formed by the build module 302 is shown.

In some embodiments, the build module 302 can be used to form a structure 344 using clay composite 340. In some examples, the build module 302 can be used to form including a wall 350 using clay composite 340. The build module 302 can pick-up discrete clay composite masses 340, and place those discrete clay composite masses 340 in a location where structure 344 is being constructed, which may (or may not) include a lattice or other framework upon which clay composite structure 340 is supported. Additionally, build module 302 can sculpt, carve an/or cute, previously positioned and now combined clay composite masses340 to refine the shape of structure 344, e.g., as shown in FIG. 3.

Referring to FIG. 3, the cables 332a-332h can extend from lifting devices 334 on a respective control towers 306a-306d to opposite and vertically spaced corners of carriage 304, allowing translational and/or rotational movement of the carriage 304. The lifting devices 334 can include pulleys, winches, cable spools, and/or motors. In some examples, a first cable 332a and a second cable 332b can extend from a first control tower 306a to a corresponding corner 352 the of carriage 304. Figure label 352 can also collectively refer to the vertically spaced corners of the carriage 304. In some examples, the first cable 332a and the second cable 332b can extend from the first control tower 306a, a third cable 332c and a fourth cable 332d can extend from a second control tower 306b, a fifth cable 332d and a sixth cable 332e can extend from a third control tower 306c, and a seventh cable 332f and an eighth cable 332h can extend from a fourth control tower 306d. Each of the cable 332a-332h can connect to their corresponding corner 352 of the carriage 304. The control towers 306a-306d can include lifting devices 334, pulleys, winches, cable spools, and motors. The spools and motors can be housed within control tower enclosures 336 of the control towers 306a-306d. In some embodiments, the lifting device 334 can include the same or similar winch system 234 described above.

In some embodiments, to raise carriage 304, the cables 332a-332h can be retracted by tower spools housed within the control tower enclosures 336. Similarly, to lower carriage 304, the cables 332a-332h can be extended by the same tower spools. To move carriage 304 in a horizontal direction, some cables 332a-332h are retracted while other cables 332a-332h extending from opposite control towers 306a-306d can be extended. The horizontal movement of carriage 304 can depend on which cables 332a-332h are extended, and/or which cables 332a-332h are retracted. The extending and/or retracting of the cables 332a-332h moves the carriage 304 around the build area 338 to form the structure 344. In one example, retracing the cables 332a, 332b and extending the cables 332e, 332f can move the carriage 304 toward the control tower 306a, e.g., similar retracting and/or extending can be done with respect to the control towers control towers 306b, 306c, 306d. In some examples, the extending and/or retracting of the cables 332a-332h provides the movement of the carriage 304 for picking-up discrete clay composite masses340, transporting discrete clay composite masses 340, and/or placing discrete clay composite masses 340 to form the structures 344. The movement of the carriage 304 can be in the x, y, and z directions. The movement can include the angle (θ) of the movement of the carriage 304 between the x, y, and z directions. The extending and/or retracting of the cables 332a-332h provides the movement of the carriage 304 for sculpting, cutting, and/or carving clay composite 340 to form the structures 344. Depending on which cables 332a-332h are extended and retracted will determine the orientation of carriage 304, allowing tools supported by carriage 304 to be oriented relative to clay composite structure and/or discrete clay composite masses340 at the build area 338. The movement of carriage 304 in all three linear directions (e.g., x, y, z) and/or orientations can occur at the same time (e.g., various angles).

In some embodiments, the build module 302 can be fully actuated and autonomous. In some examples, the build module 302 can use machine vision devices, e.g., such as mounted cameras, to register a position of the carriage 304 in relation to computer vision tags and/or markers 348 dispersed across a build site. In some examples, localization information can be gathered by the build module 302 based on the computer vision tags and/or marker 348. In some examples, when assembling discrete clay composites into a 3D structure, the build module 302 can include and/or be referred to as a 3D printer.

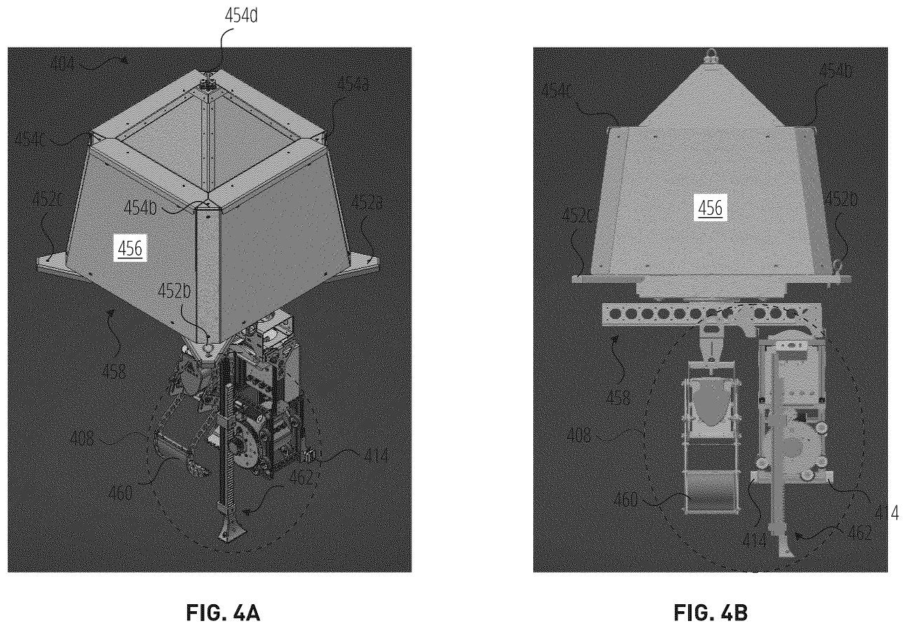

Referring to FIG. 4A and FIG. 4B, plan views of a carriage 404 is shown, according to some embodiments. In some embodiments, the carriage 404 can be transportable and/or modular, able to be assembled, disassembled, and is reconfigurable. The carriage 404 can include build tools 408. The build tools 408 can be mounted onto the carriage 404. The build tools 408 can include a robot arm, crane, claw 460, impulse hammer 462, saw, drill, or other end effectors, among other tools and/or equipment. In some examples, an impulse hammer can include a compaction tool. The carriage 404 can include a carriage enclosure 456 to which cables of a build module (e.g., the build modules 102, 202, 302) can be attached. The carriage 404 can house a variety of tools with which can be attached to an underside 458 of the carriage enclosure 456. The carriage 404 can include a cable driven robot (CDR). The build tools 408 can include interchangeable tools. In some examples, the build tools 408 can include a wire operated, over-actuated, light weight crane having a variable scale. The carriage 404 can include sensors. The sensors can be used to detect the location of the carriage 404 while performing compound manufacturing. The carriage 404 can include machine vision devices 414 can include camera and/or other vision-based equipment. In some examples, the machine vision device 414 can generate localization information of the carriage 404 over a build area by registering positions of the carriage 404 in relation to computer vision tags and/or markers dispersed across the build area.

In some embodiments, the carriage 404 can include corners 452a, 452b, 452c, 452d. The corners 452a-452d can collectively be referred to as corners 452. The corners 452 can correspond to the corners 352 described in FIG. 3.

In some embodiments, when assembling discrete clay composites into a monolithic wall and/or other structure, the carriage 404 can perform construction tasks and/or functions of a build module (e.g., the build modules 102, 202, 302). In some embodiments, when the carriage 404 can be used to perform and/or can be configured to perform tasks that include lifting and/or lowering a material and/or object using the claw 460. In some examples, in holding and/or positioning various tools attached to the carriage 404 (e.g., claw 460, impact hammer 462, drill, etc.), the carriage 404 can act as a crane for those particular tools. The carriage 404 can act as an extension of the tools, e.g., the carriage 404 can act as a given tool when that tool is in operation (e.g., the carriage 404 can be both the hammer and the hammerer). The carriage 404 can be piloted and/or controlled by the processing module 116, 216. The carriage 404 can be piloted and/or controlled by an artificial intelligence (AI) module of the processing module 116, 216. The AI module can control both the carriage 404 and/or any of the interchangeable tools 460, 462, that there attached to the carriage 404.

In some embodiments, to perform formative construction, the carriage 404 can include the hammer 462. In some examples, the hammer 462 can be attached to the carriage 404 as shown. The hammer 462 can include an impact hammer. The hammer 462 can be used by the carriage 404 to compress and/or sculpt each layer of clay composite material (240, 340). The hammer 462 be used by the carriage 404 to compress and/or sculpt from a top and/or sides of the clay composite material, e.g., to create an overall denser structure.

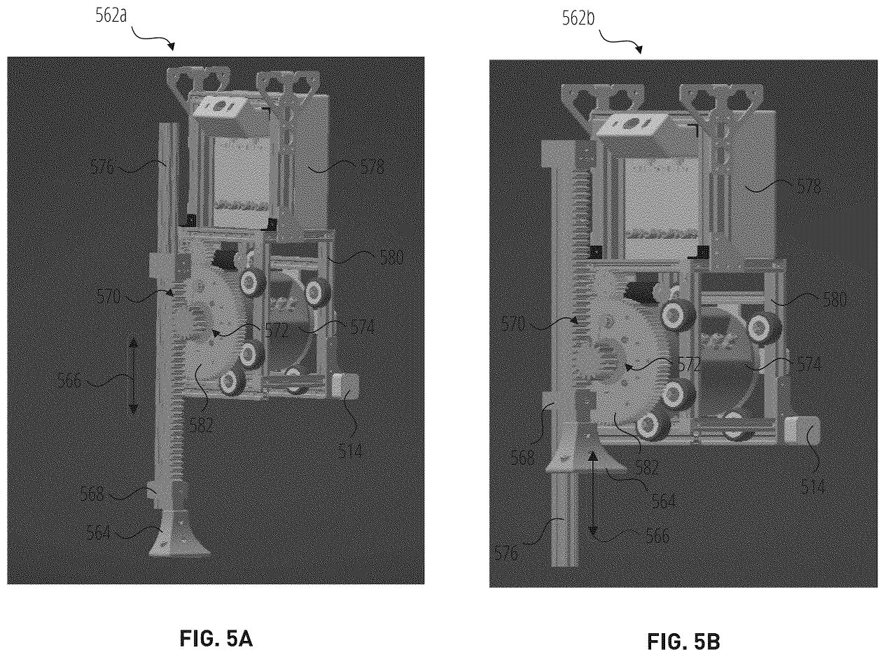

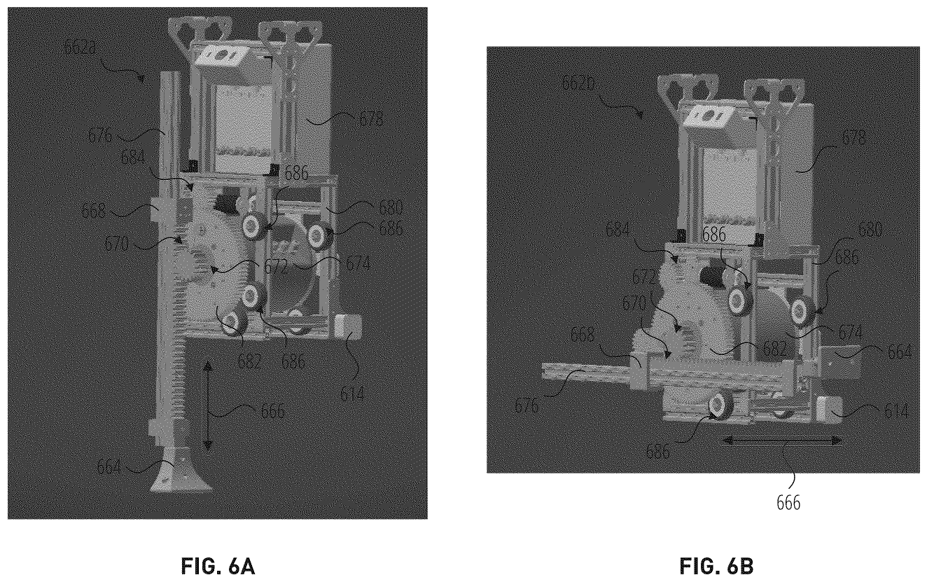

Referring to FIG. 5A and FIG. 5A, plan views of a hammer for a build tool is shown, according to some embodiments. FIG. 5A shows the hammer in an extended position 562a, and FIG. 6B shows the hammer in a retracted position 562b. The hammer 562a, 562b can collectively be referred as hammer 562. The hammer 562a, 562b includes a hammer head 564 that can be moveable in a linear direction 566 relative to a frame 580. The hammer 562a, 562b can be moved in the linear direction 566 to pound clay composite material by repeatedly extending and retracting 566 the hammer 562a, 562b. The hammer head 564 can actuate relative to a frame 580 on a linear rack 570 and pinion 572 powered by a motor 574. The rack 570 includes collars 568 mounted on a rail 576, which can be mounted on the motor 574. The hammer 562a, 562b rotates relative to frame 580 on a gear 582. The collars 568 can slide on the rail 576. The motor 574 can rotate the pinion 572 relative to the rack 570 in a clockwise direction to move rack 570 vertically up to retract hammer head 564. The motor 574 can rotate the pinion 572 in a counterclockwise direction to move rack 570 vertically down to extend the hammer head 564. The electronic components 578 can be used to control the movement of the hammer 562a, 562b. In some examples, the electronic component 578 can be used to extend and retract the hammer head 564, and to repeatedly pound and/or compress the clay composite until the clay composite based structure forms a target shape. The hammer 562a, 562b can have interchangeable hammer heads 564 that can be used to and/or configured to smoothen and/or shape the structure to be formed. The hammer 562a, 562b can have interchangeable hammer heads 564 that can be used to add a haptic, textured finish.

Referring to FIG. 6A and FIG. 6B, plan views of the hammer for a build tool is shown, according to some embodiments. FIG. 6A shows the hammer in a vertical position 662a, and FIG. 6B shows the hammer in a horizontal position 662b. The hammer 662a, 662b can collectively be referred as hammer 662. The hammer 662a, 662b includes a hammer head 664 that can be moveable in a linear direction 666 relative to a frame 680. The hammer 662a, 662b can be moved in the linear direction 666 to pound clay composite material by repeatedly extending and retracting 666 the hammer 662a, 662b. The hammer 662a, 662b is rotatable relative to the carriage (e.g., carriage 104, 204, 304, 404), allowing it to be oriented in various positions, such as a hammer in a vertical position 662a shown in FIG. 6A, and a hammer in a horizontal position 662b shown in FIG. 6B, and other positions therebetween. The hammer 662a, 662b rotates relative to frame 680 on a gears 682, 684, 686, driven by a motor 674 powered by the electronic component 678. The motors 674 can rotate the gears 682, 684, in a clockwise direction to move the hammer into from the vertical position 662a shown in FIG. 6A to the horizontal position 662b shown in FIG. 6B. The motors 674 can rotate the gears 682, 684, in a counter-clockwise direction to move the hammer into from the horizontal position 662b shown in FIG. 6B to the vertical position 662a shown in FIG. 6A. Rollers 686 on the frame 680 facilitate the rotation of hammer 662a, 662b between vertical 662a and horizontal positions 662b. The electronic component 678 can facilitate the rotation between vertical position 662a, horizontal position 662b, and any other orientations in-between. Moving the hammer 662a, 662b in this way can allow hammer 662a, 662b (and/or any other build tool) to engage the clay composite structure and/or discrete pieces of clay composite at different angles, either from a top direction, a side, any angle, and/or any direction therebetween. The electronic component 678 can deliver power to any build tool described herein (e.g., to a claw, crane, among the other build tools).

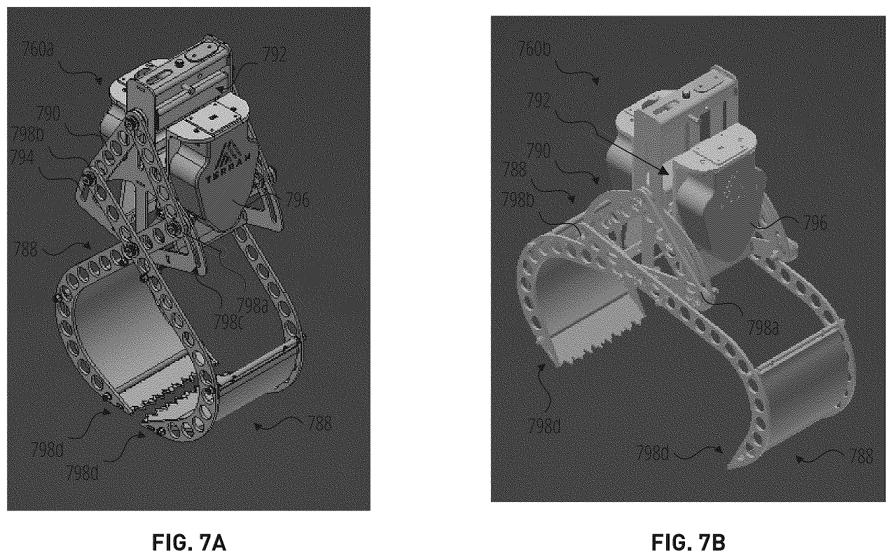

Referring to FIG. 7A and FIG. 7B, a plan view of a claw for a build tool is shown, according to some embodiments. FIG. 7A shows the claw closed 760a, and FIG. 7B shows the claw open 760b. The claw 760a, 760b can collectively be referred as claw 760. In some embodiments, the claw 760 can be used, and/or is configured, to lift and/or help lift objects including discrete pieces of clay composites. In some examples, the build tools described herein, e.g., build tools 108, 208, 308, 408, can act as a crane when the claw 760 is installed.

Referring again to FIG. 7A and FIG. 7B, the claw 760a, 760b includes a claw member 788 pivotably attached to claw frame 794, a pair of actuator links 790, shuttle 792 linearly attached to the claw frame 794, and an electric drive 796 attached to the claw frame 794 and powered by an electronic component. Lower ends 798a of the actuator links 790 can be connected to upper ends 798b of the claw members 788. The upper ends 798b of the actuator links 790 can be connected to the shuttle 792. The claw frame 794 includes a pair of arched slots 798c in which the upper ends 798b of the claw members 788 and the lower ends 798a of actuator links 790 travel. In some examples, the electric drive 796 can move the shuttle 792 up and down to move the upper ends 798b of the claw members 788 up and down, correspondingly. In some embodiments, the opening 760b and closing 760a of the claw members 788 can be actuated by the movement of the lower ends 798a of the actuator links 790 and the upper ends 798b of the claw members 788 along the arched slots 798c. In some examples, when a carriage of the build module is moved to a location within the build area to pick or place a discrete piece of clay composite, the shuttle 792 (e.g., controlled by the electric drive 796) can be moved up to pick the discrete piece of clay composite, or moved down to place the discrete piece of clay composite.

### Methods for Clay Composite Based Construction

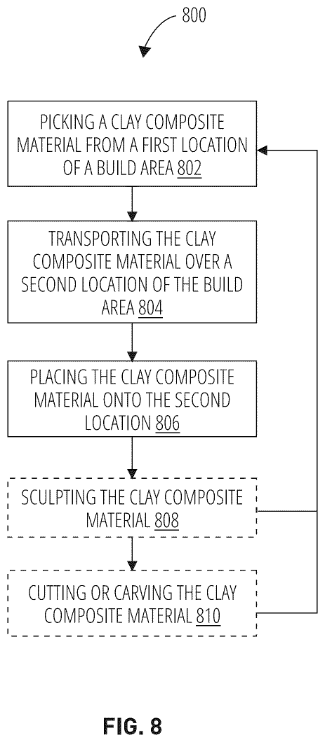

Referring to FIG. 8, a flowchart 800 for a method for forming clay composite based structures 800 is shown, according to some embodiments. In some examples, composite based structures can include structural walls, nonstructural wall frames, fire walls, party walls, door apertures, window apertures, built-in furniture, and architectural ornamentation, among other structural and non-structural elements built using the clay composites.

At a step 802, the method can include picking a clay composite material from a first location of a build area 802. The clay composite material can include the clay composite materials described herein. In some embodiments, step 802 can include picking discrete clay composite materials such as clay composites 240, 340 described in FIG. 2 and FIG. 3, and/or clay composites having the properties in FIG. 1A. The fist location can include a location on the build area with a stack or pile 242 of discrete pieces of clay composites. Step 802 can include using a claw attached to a carriage of a build module to pick-up the clay composite material.

At a step 804, the method can include transporting the clay composite material over a second location of the build area 804. In some embodiments, step 804 can include moving the clay composite material clamped by the claw of the build module over a second location of the build module. The second location of the build area that is the same location as the first location, a different location, and/or a separate location from the first location. Moving the claw can include retracting and extending cables connected to control towers and to the carriage of the build module.

At step 806, the method can include placing the clay composite material onto the second location 806. In some embodiments, step 806 can include placing clay composite materials in a line atop one another to build a layered structure. In some examples, performing steps 802-806 can include performing an additive construction process. Additive construction can include using a claw attachment of the build module to pick, transport, and place each piece of clay composite from the first location and positioning each discrete piece of clay composite in a layered formation to form a structure such as a wall. Step 806, can include using gravity to place the clay composite material onto the second location. In some examples, at step 806 gravity can be used to bind the clay composite materials together. In one non-limiting example, gravity can be used to bind the clay composite materials together to form a monolithic, microfiber reinforced structure such as a wall. Steps 802-806 collectively include picking the clay composite materials, moving the clay composite materials, positioning the clay compositing materials over a target location over the build area, and placing the clay composite materials by dropping the clay composite materials over the target location from a target height. The target height can be defined based on the material of the clay composite materials. In some examples, the target height can be calculated based on the weight of the clay composite materials, the shape of the clay composite materials, and/or the configuration of the structure to be built.

At an optional step 808 the method can include sculpting the clay composite materials 808. In some embodiments, step 808 can include sculpting, smoothening, and/or shaping the clay composite materials based on a plan and/or the target structure to be formed. In some examples, performing steps 802-806 can include performing formative construction. Formative construction can include deforming, displacing, compressing, and/or sculpting clay composite materials for construction of a structure. In some examples, formative construction can be used for reinforcing the structural integrity of a structure, and/or improving the aesthetics of the structure. In one non-limiting example, formative construction can be used to form and/or sculpt the clay composite materials, e.g., no additional materials are added, and/or minimal material can be subtracted when performing formative construction. Other rammed earth construction techniques use formwork and/or shuttering to build temporary structures as a base around the material to be formed, e.g., using planks to form a general shape of a wall, and filling a void within the planks with earthen material to create the wall. In contrast to the other rammed earth construction techniques, partial formwork, no formwork, and/or shuttering is performed using formative construction. In some embodiments, performing a combination of additive and/or formative construction steps can provide for flexibility in an overall shape and/or form of the structure to be formed. In some examples, performing 802-808 can include forming a curved wall that can follow an irregular shaped structure and/or path. Steps 802-808 can be used to form a camber i.e., a slope or batter which can get thinner with altitude, and/or blend the structure into built-in earthen furniture, engaged columns, and buttresses. The earthen furniture, engaged columns, and buttresses can be constructed out of the clay composite material using the formative construction techniques. Formative construction can also be referred to herein as formative manufacturing techniques, among other terms. In some embodiments, transporting the clay composite material over a second location of the build area 804 can include using the build module to form a cob structure, a rammed earth structure, a pisé structure, among other structures. The formative construction can be used to form ornamental flourishes and/or textural imprints made directly into the structures. In some examples, the un-sculpted and/or un-hammered structure can include a structure that is purely an additive version of the structure. The un-sculpted and/or un-hammered structure can include a rough, and/or uneven surface. Step 808, can include sculpting and/or be bind the clay composite pieces together. Gravity can be used to sculpt the clay composite pieces together to form a monolithic, microfiber reinforced structure such as a wall. In some examples, step 808 can be used to form a wall by performing additive construction to pick a clay composite material, move the clay composite material, position the clay composite, and place the clay composite material by dropping the clay composite material over a target location from a target height. The target height can be chosen for binding the clay composite materials together. In some examples, the target height can be calculated based on the weight of the clay composite, the shape of the clay composite, and/or the configuration of the structure to be built. In some embodiments, step 808 is optional and step 806 can proceed directly to step 810. Subsequent to performing step 808, the method 800 can return to step 802 or proceed to step 810.

At an optional step 810, the method can include cutting or carving the clay composite materials 810. In some embodiments, step 810 can include removing portions of the clay composite materials subsequent to steps 806 or 808. In some examples, performing steps 802 810 can include performing subtractive construction. Subtractive construction can include cutting, sawing, smoothening and/or shaping the clay composite materials based on a plan and/or the target structure to be formed. Subtractive construction can be used for improving aesthetics of the structure and/or to increase the structure's structural integrity. Subtractive construction can be used to remove and augment the structures. In some examples, subtractive construction can be used to remove and augment the wall assemblies created in the initial additive construction. In some embodiments, step 810 can include using subtractive based tools including a drill, a saw, among other tools and/or attachments. In some examples, step 810 can include removing a section of the structure. Step 810 can include removing a section of a wall. Step 810 can include creating apertures, e.g., windows, doors, and chases) in previously solid walls. In one example, step 810 can include removing portions of the structure to add vertical steel reinforcement to the structures. Step 810 can include drilling holes into the wall, where the vertical steel bars can be placed to reinforce the wall. Step 810 can be optional, and need not be performed to form the structure to be formed. Subsequent to performing step 810, the method 800 can return to step 802 or the method can be completed once the structure to be formed is fully built.

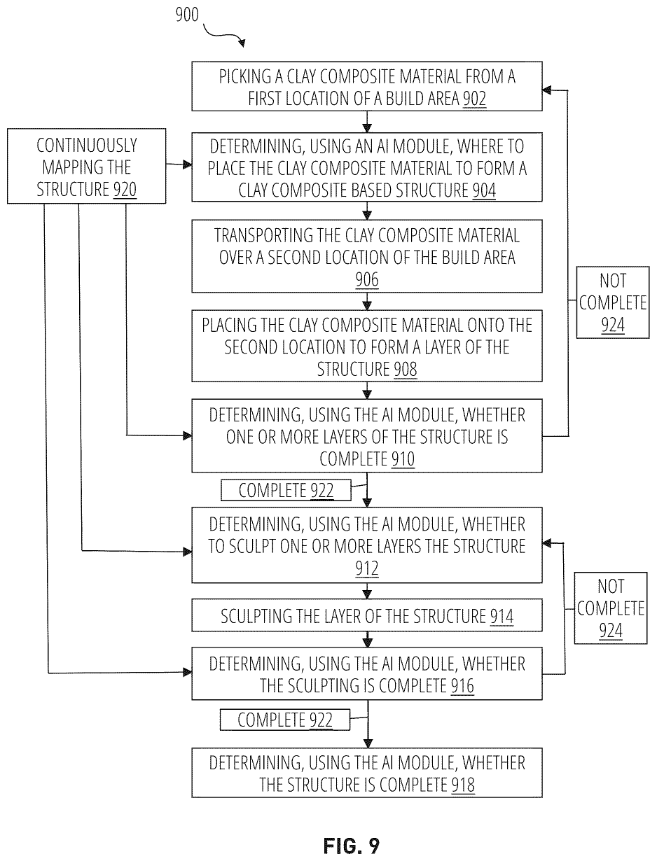

Referring to FIG. 9, a flowchart 900 for a method for forming clay composite based structures 900 is shown, according to some embodiments. In some embodiments, the steps described in flowchart 900 can be the same or similar to the steps described in flowchart 800 above. Therefore, the description for similar or the same steps in flowchart 800 can apply to the same or similar steps in the flowchart 900. In some examples, step 902 can be similar or the same to step 802 of flowchart 800, where the description for step 802 can apply to step 902. As used herein clay composite based structures can be referred to as clay composite structures, and/or structures, among other terms.

At a step 902, the method can include picking a clay composite material from a first location of a build area 902. Step 902 can be the same or similar or the same to step 802.

At a step 904, the method can include determining, using an AI module, where to place the clay composite material to form a clay composite based structure 904. In some examples, the AI module can include the AI module 118 from FIG. 1B. In some embodiments, the AI module can be trained on completed composite based structures. In some examples, the AI module can be trained on what the completed clay composite based structures look like. The AI modules can be trained on a dataset, heuristics, e.g., in some instances self-built datasets or heuristics. In some embodiments, the AI module can be configured to determine where to place the clay composite material to form the clay composite based structures based on trained data generated from completed clay composite based structures, a dataset, heuristics, among other data sources.

At step 906, the method can include transporting the clay composite material over a second location of the build area 906. Step 906 can be similar or the same to step 804.

At step 908, the method can include placing the clay composite material onto the second location to form a layer of the structure 908. Step 908 can be similar or the same to step 806.

At a step 910, the method can include determining, using the AI module, whether one or more layers of the structure is complete 910. In some embodiments, the AI module determines whether the layer of the structure is complete based on trained data generated from completed clay composite based structures, a dataset, heuristics, among other data sources. In some examples, if the layer of the structure is determined to be complete 922, the method proceeds to step 912. If the layer of the structure is determined to be not complete 924, the method proceeds back to step 902.

At step 912, the method can include determining, using the AI module, whether to sculpt one or more layers the structure 912. In some examples, step 912 can include determining, using the AI module, whether to sculpt the layer from above the structure, and/or whether to sculpt the layer from one or more sides of the structure. In some embodiments, the AI module can be configured to determine whether to sculpt one or more layers the structure based on trained data generated from completed clay composite based structures, a dataset, heuristics, among other data sources.

At step 914, the method can include sculpting the layer of the structure 914. Step 914 can be similar or the same to step 808. In some examples, step 914 can include sculpting the layer of the structure from above and/or from one or more sides of the layer of the structure.

At step 916, the method can include determining, using the AI module, whether the sculpting is complete 916. In some examples, step 916 can include determining, using the AI module, whether sculpting from above or from one or more sides of the structure is complete. In some embodiments, the AI module determines whether the sculpting is complete based on trained data generated from completed clay composite based structures, a dataset, heuristics, among other data sources. In some examples, if the sculpting is determined to be complete 922, the method proceeds to step 918. If the sculpting is determined to be not complete 924, the method proceeds back to step 912. In some embodiments, steps 912-916 can be optional, and in this case step 910 can proceed directly to step 918 once it is determined that one or more layers of the structure, and/or the entire structure, is complete.

At step 918, the method can include determining, using the AI module, whether the structure is complete 918. In some embodiments, the AI module determines whether the construction of the structure is completed based on trained data generated from completed clay composite based structures, a dataset, heuristics, among other data sources.

At step 920, the method can include continuously mapping the structure 920. In some examples, step 920 can include continuously mapping the structure while the structure is being built. Step 920 can including generating mapping data based on the mapping performed at step 920. Step 920 can include sending the mapping data to steps 904, 910, 912, and/or 916. The mapping can include using sensors, imaging devices, cameras, LIDAR devices, to map the structure and/or generate mapping data from the structure. In some examples, the mapping can be stored as mapping data. The mapping data can be used by the AI module at the one or more steps of the method 900. In some examples, the AI module can receive and/or use the mapping data at steps 904, 910, 912, and/or 916.

### Hardware and Software Implementations

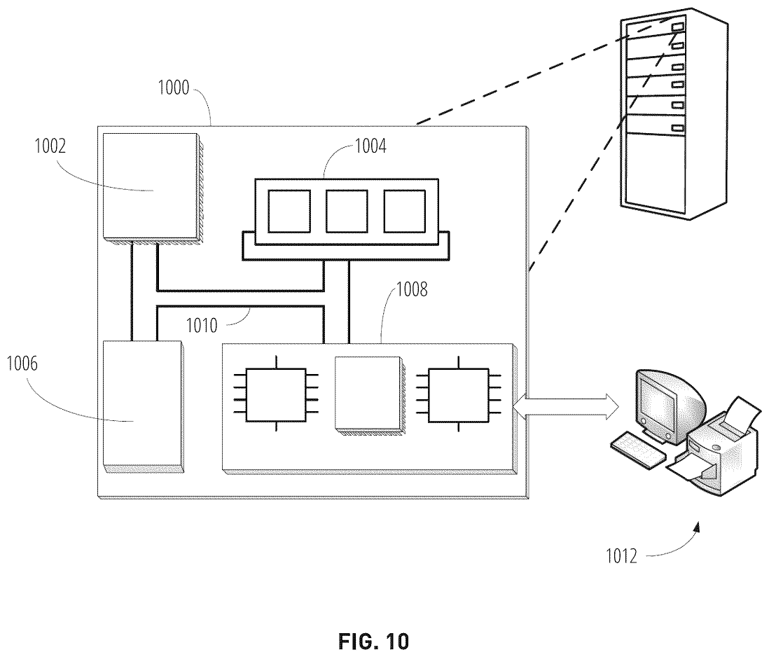

FIG. 10 is a block diagram of an example system 1000 that may be used in implementing the technology described in this document. As described herein, the system 1000 can also be referred to as a computer system 1000, among other terms. General-purpose computers, network appliances, mobile devices, or other electronic systems may also include at least portions of the system 1000. The system 1000 includes a processor 1002, a memory 1004, a storage device 1006, and an input/output device 1008. Each of the processor 1002, 1004, 1006, and 1008 may be interconnected, for example, using a system bus 1010. The processor 1002 is capable of processing instructions for execution within the system 1000. In some implementations, the processor 1002 is a single-threaded processor. In some implementations, the processor 1002 is a multi-threaded processor. The processor 1002 is capable of processing instructions stored in the memory 1004 or on the storage device 1006.

The memory 1004 stores information within the system 1000. In some implementations, the memory 1004 is a non-transitory computer-readable medium. In some implementations, the memory 1004 is a volatile memory unit. In some implementations, the memory 1004 is a non-volatile memory unit.

The storage device 1006 is capable of providing mass storage for the system 1000. In some implementations, the storage device 1006 is a non-transitory computer-readable medium. In various different implementations, the storage device 1006 may include, for example, a hard disk device, an optical disk device, a solid-date drive, a flash drive, or some other large capacity storage device. For example, the storage device may store long-term data (e.g., database data, file system data, etc.). The input/output device 1008 provides input/output operations for the system 1000. In some implementations, the input/output device 1008 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 1012. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 1006 may be implemented in a distributed way over a network, for example as a server farm or a set of widely distributed servers, or may be implemented in a single computing device.

Although an example processing system has been described in FIG. 10, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; and magneto optical disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system for clay composite based construction, the system comprising:
control towers spaced apart and surrounding a build area;
a carriage having build tools suspended over the build area by cables attached to, and supported by, the control towers;
the build tools comprising:
a claw for picking-up clay composite materials from the build area, transporting the clay composite materials, and placing clay composite materials onto the build area; and
a hammer for sculpting the clay composite materials placed onto the build area; and
a processing module connected to the control towers, the processing module controlling the operation of the carriage to form clay composited based structures.

2. The system of claim 1, wherein the control towers comprise at least 4 control towers.

3. The system of claim 1, wherein the system comprises a cable driven robot.

4. The system of claim 1, further comprising at least one of communication devices, sensors, or machine vision devices.

5. The system of claim 1, wherein the build tools further comprise at least one of a claw, saw, drill, impulse hammer, or end effectors.

6. The system of claim 1, wherein the processing module comprises at least one of an artificial intelligence module, a machine vision module, a storage module, a communication module, a control module, or an user interface module.

7. The system of claim 1, wherein the control towers comprise at least one of pulleys, winches, cable spools, or motors.

8. The system of claim 1, wherein the processing module is configured to use an artificial intelligence module to control the operation of the carriage to form clay composited based structures.

9. The system of claim 1, wherein the clay composite materials comprise at least one of clay aggregates, fibers, microfibers, cob, or viscous cob materials.

10. A method for forming clay composite based structures, the method comprising:
picking-up a clay composite material from a first location of a build area;
transporting the clay composite material over a second location of the build area;
placing the clay composite material onto the second location;
sculpting the clay composite material; and
cutting or carving the clay composite material to form a clay composite based structure.

11. The method of claim 10, wherein picking-up the clay composite material comprises using a claw attached to a carriage to pick up a clay composite material from the build area.

12. The method of claim 10, wherein transporting the clay composite material comprises using a claw and a carriage driven by cables attached to control towers.

13. The method of claim 10, wherein placing the clay composite material comprises using a claw attached to a carriage to place the clay composite material onto the build area.

14. The method of claim 10, wherein picking-up, transporting, and placing the clay composite materials comprises picking-up, transporting, and placing the clay composite material to form a monolithic structure.

15. The method of claim 10, further comprising using sensors and machine vision devices to determine a first location to pick-up the clay composite materials.

16. The method of claim 10, further comprising using sensors and machine vision devices to determine a second location to place the clay composite materials.

17. The method of claim 10, wherein the first location is a separate, different, location from the second location.

18. The method of claim 10, wherein sculpting the clay composite material comprises using a hammer to sculpt the clay composite material into a clay composite based structure.

19. The method of claim 10, wherein cutting or carving the clay composite material comprises using a saw to cut or carve the clay composite material into a clay composite based structure.

20. The method of claim 10, wherein cutting or carving the clay composite material is performed subsequent to sculpting the clay composite material.
